(19) United States
(12) Patent Application Publication
(10) Pub. No.: US 2007/0160238 A1
(43) Pub. Date: Jul. 12, 2007

(54) Bone conduction device

(75) Inventor: Kazuji Kobayashi, Tokyo (JP)

Correspondence Address: SCHMEISER, OLSEN & WATTS, 22 CENTURY HILL DRIVE, SUITE 302, LATHAM, NY, 12110, US

(73) Assignee: TEMCO JAPAN CO., LTD., SUGINAMI-KU TOKYO JAPAN (JP)

(21) Appl. No.: 10/597,825

(22) PCT Filed: Mar. 4, 2005
(86) PCT No.: PCT/JP05/03719

§ 371 Date: Aug. 9, 2006

(30) Foreign Application Priority Data
Mar. 5, 2004 (JP) 200-062034

(51) Int. Cl. H04R 25/00

(52) U.S. Cl. 381/151

(57) ABSTRACT

The object is to provide a bone conduction device. The device is simple in construction, thin in thickness, small in leakage in magnetic flux, excellent in performance, and comprises: abase yoke (1) carrying both a voice coil (3) and a magnet (4); and, a front yoke (5). The yoke (5) assumes a flat plate-like shape and is loosely disposed between: an upper surface of a magnetic pole of the base yoke (1); and, the front yoke (5) to provide a necessary clearance between these yokes. The device is characterized in that the clearance is produced by means of a resilient element (6), which is disposed in an outer peripheral portion of the base yoke (1) to receive the front yoke (5) thereon. Preferably: the base yoke (1) has a circular base (7); and, the resilient element (6) assumes an arcing shape extending along the base (7).

### TECHNICAL FIELD

The present invention relates to a bone conduction device, and more particularly to a high performance bone conduction device, which is thin in thickness, small in leakage in magnetic flux and is formed into a speaker or a microphone, each of which is of a type capable of transmitting a voice sound signal as a bone conduction sound. Incidentally, a bone conduction microphone has substantially the same construction as that of a bone conduction speaker. Consequently, in the following description, only the bone conduction speaker will be described. However, it is natural that the following description is also applicable to the bone conduction microphone itself.

### BACKGROUND ART

As shown in FIGS. 6 and 7, it has been known in the art that: a lower yoke 21 is provided with a central magnetic pole 22, which a voice coil circumscribes; the lower yoke 21 extends in four different directions to form four pieces of extensions, in each of two of which extensions an upper yoke fixture portion 25 is provided to extend upward; and, a vibrating plate or diaphragm 27 of an upper yoke 26 is fixedly mounted on the upper yoke fixture portion 25 (see Japanese Patent No. 2967777).

The upper yoke 26 is constructed of: a plate yoke 28, which is thick in thickness and forms a portion of a magnetic circuit; and, a flexible vibrating plate 27, which is thin in thickness. In order to obtain a sufficient performance, it is necessary for the vibrating plate 27 to have its effective area made as large as possible. In order to make the area of the vibrating plate 27 as large as possible without increasing its entire size, it is necessary to reduce the plate yoke 28 in size and in width.

However, when the plate yoke 28 is reduced in size and in width, there is a fear that leakage in magnetic flux tends to occur. Under such circumstances, there is a fear that such leakage in magnetic flux exerts an aggravating effect on a hearing aid and like instruments.

Further, in order to mount the plate yoke 28 in a casing 29 for transmitting a vibration to a human body, a screw 30 is threadably engaged with a threaded hole 31 provided in the yoke plate 28, so that the plate yoke 28 is fixedly mounted on an inner surface of the casing 29. In this case, however, such threadable engagement of the screw 30 produces iron dust particles. When these iron dust particles enter a clearance formed between the upper yoke 26 and an upper surface of the central magnetic pole 22, they tend to produce an abnormal noisy sound. Further, in order to use such a screw in assembly, the casing 29 must be thick in thickness, this makes it impossible to reduce the casing 29 in thickness as a whole, which makes it impossible to cope with the need of reducing the casing 29 in thickness.

Patent document 1: Japanese Patent No. 2967777.

### DISCLOSURE OF THE INVENTION

### Problems to be Solved by the Invention

The present invention was made to solve the problems inherent in the conventional bone conduction device. Consequently, it is an object of the present invention to provide a bone conduction device, which is simple in construction, thin in thickness, small in leakage in magnetic flux and excellent in performance.

### Means for Solving the Problems

In the present invention, the above object is accomplished by providing a bone conduction device, which is simple in construction, thin in thickness, small in leakage in magnetic flux, excellent in performance, and comprises: a base yoke carrying both a voice coil and a magnet; and, a front yoke. The front yoke assumes a flat plate-like shape, and is loosely disposed so as to provide a necessary clearance between: an upper surface of a magnetic pole of the base yoke; and, the front yoke.

The device is characterized in that the clearance is produced by means of a resilient element, which is disposed in an outer peripheral portion of the base yoke to receive the front yoke thereon. Preferably: the base yoke has a circular base; and, the resilient element assumes an arcing shape extending along the base.

In the present invention, the above problems are solved also by providing a bone conduction device comprises: a base yoke carrying both a voice coil and a magnet; and, a front yoke, which assumes a flat plate-like shape and is loosely disposed so as to provide a necessary clearance between: an upper surface of a magnetic pole of the base yoke; and, the front yoke, wherein the device is characterized in that the clearance is produced by means of a damper, which is mounted on the base yoke to have its peripheral edge supported by an inner surface of the casing.

Preferably, the front yoke is fixedly mounted on an inner surface of a casing without using any screw. Further, the front yoke is fixedly mounted in a yoke reception portion of the inner surface of the casing in an insertion manner.

### EFFECT OF THE INVENTION

In the bone conduction device of the present invention: the resilient element or damper is mounted on the base yoke which carries both the voice coil and the magnet; and, the clearance is produced and kept between the upper surface of the magnetic pole of the base yoke and the front yoke. Due to this construction, in the bone conduction device of the present invention, there is no need of providing any thick-wall and thin-wall portion. Therefore, in the bone conduction device of the present invention, there is substantially no leakage in magnetic flux, which leakage is resulted from formation of such thick-wall and thin-wall portion. Due to this, it is possible for the bone conduction device of the present invention not to exert any bad influence on a hearing aid and like instruments.

Further, it is possible for the present invention to provide the bone conduction device, which is simple in construction, thin in thickness, compact in size as a whole, and relatively low in manufacturing cost. In addition, since it is possible to assemble the bone conduction device of the present invention without using any screw, there is no fear that iron dust particles are produced in the assembly operation of the bone conduction device of the present invention. Due to this, in effect of the present invention, it is possible for the bone conduction device of the present invention to keep its excellent performance through its long-term service life.

### BEST MODE FOR CARRYING OUT THE INVENTION

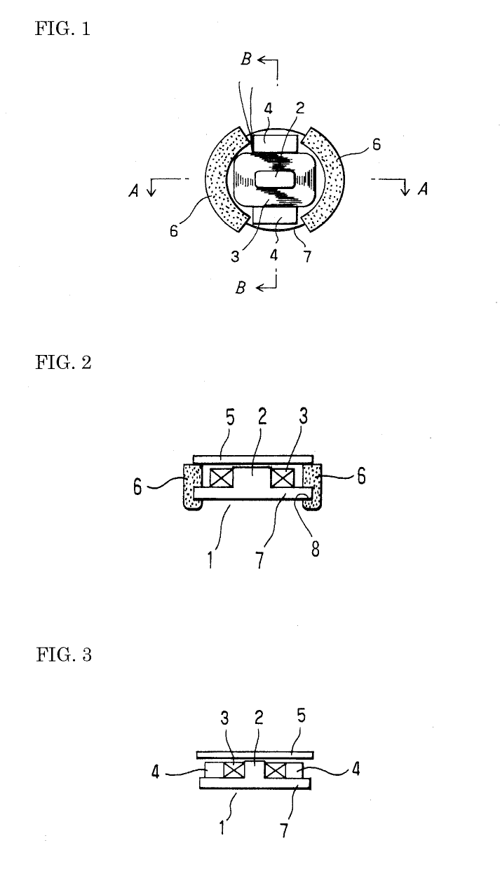

Preferred embodiments for carrying out the present invention will be described with reference to the accompanying drawings. FIGS. 1 to 4 show a first embodiment of the present invention. The first embodiment is of an outer magnet type, in which a magnet 4 is disposed outside a voice coil 3. The first embodiment is constructed of: a base yoke 1 provided with a central magnetic pole 2; the voice coil 3 circumscribing the central magnetic pole 2; a pair of the magnets 4, which are diametrically oppositely disposed from each other so as to sandwich the voice coil 3 between these magnets; a front yoke 5 disposed on the base yoke 1 through a resilient element 6.

In general, a base 7 of the base yoke 1 assumes a circular shape. The resilient element 6 is made of resilient material such as plastics and the like, generally assumes an arcing shape extending along a peripheral edge of the base 7 and is disposed between the magnets 4, 4 which are fixedly mounted on the base 7. The resilient element 6 is mounted on the base 7 in a manner such that, for example, an insertion groove 8 is formed in an inner peripheral surface of the resilient element 6 for receiving therein a peripheral edge portion of the base 7 in an insertion manner. Preferably, the peripheral edge portion of the base 7 is fixedly mounted in the insertion groove 8 of the resilient element 6 by bonding, if necessary.

In diameter, the front yoke disposed on the resilient elements 6, 6 is substantially the same as the base 7 of the base yoke 1 in general. Consequently, the resilient elements 6, 6 extend slightly outward over the front yoke 1. Produced between an upper surface of the central magnetic pole 2 of the base yoke 1 and the front yoke 5 is an appropriate clearance. This clearance is produced by both the base yoke 1 and the front yoke 5 mounted on the resilient elements 6, 6 in the above-mentioned manner.

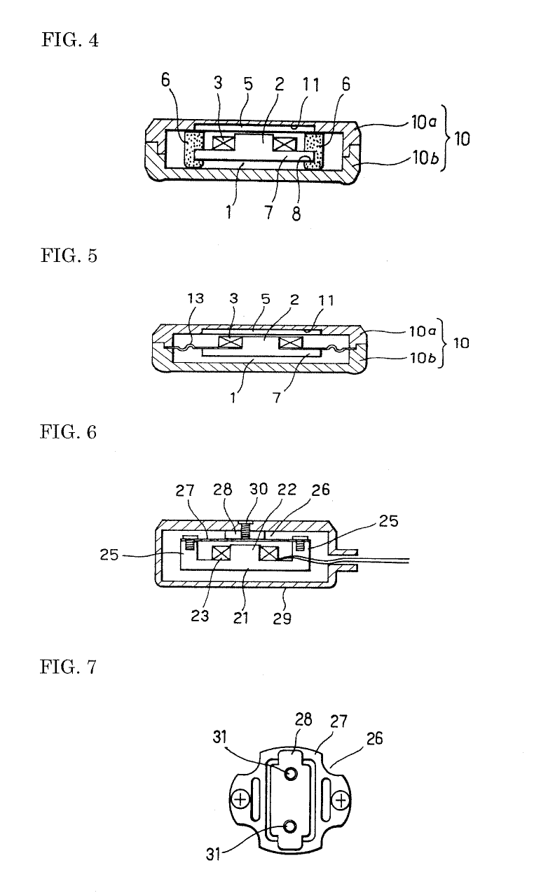

FIG. 4 shows an example in which the bone conduction device of the present invention is mounted in its casing 10. The casing 10 is of a two-pieces split type, a half portion 10a of which is thin in thickness to form a yoke reception portion 11 for receiving therein the front yoke 5. In general, the bone conduction device has its front yoke 5 received in the yoke reception portion 11, so that the front yoke 5 is mounted in the half portion 10a of the casing 10. After that, the remaining half portion 10b of the casing 10 is coupled with the half portion 10a in a manner such that the resilient elements 6, 6 are strongly sandwiched and held between these half portions 10a, 10b.

When the bone conduction device is built in the casing 10: the front yoke 5 is bonded to the yoke reception portion 11, if necessary; and, the resilient element 6 is bonded to each of the half portion 10a and the remaining half portion 10b at their abutting surfaces. In this case, it is possible to enlarge the bonded surfaces in bonded portions, which makes it possible to obtain a sufficient amount of bonding power required in firmly fixing these bonded portions. In the present invention, any screw is not required as described in the above. Due to this: the present invention is free from the problem of iron dust particles, which are inevitably produced in screw-type mounting operation; and, it is possible to reduce the casing in thickness in construction.

Although the bone conduction device of the present invention operates according to the same principle as that of the conventional device, the cone conduction device of the present invention is much more simpler in construction. More specifically, in the present invention, a vibration of the front yoke 5 is supported by the resilient element 6. Due to this, in the present invention, there is no need of providing any thin and flexible portion in the front yoke 5. Consequently, the bone conduction device of the present invention is small in leakage in magnetic flux. Due to this, when the bone conduction device of the present invention is used in a hearing aid and like instruments, there is no fear that the hearing aid and like instruments are affected by the presence of the bone conduction device of the present invention. In other words, the fact that the bone conduction device of the present invention is small in leakage in magnetic flux means that the magnetic flux is effectively used in the present invention. This means that the magnet 4 required in the present invention is sufficiently reduced in size and therefore in manufacturing cost.

In an embodiment shown in FIG. 5: in place of the resilient element 6 for supporting the base yoke 1 or for keeping the clearance between the upper surface of the central magnetic pole 2 and the front yoke 5, a damper 13 is employed.

Such damper 13 is made of paper, plastics, or metal such as one assuming a thin metal plate, and provided with an appropriate flexibility in performance. The damper 13 has: its central portion fixedly mounted on an upper surface or a lower surface of the base 7 of the base yoke 1 (in FIG. 5, the central portion of the damper 13 is fixedly mounted on the upper surface); and its peripheral edge portion fixedly mounted on an inner peripheral surface of the casing 10 by having this peripheral edge portion sandwiched between abutting portions of the half portion 10a and the remaining half portion 10b of the casing 10 (see FIG. 5).

It is needless to say that the present invention is also applicable to an inner magnet type of the bone conduction device, in which type the magnet 4 is disposed inside the voice coil 3.

While the present invention has been described in detail to some extent with reference to the preferred embodiments thereof, it will be understood by those skilled in the art that various changes in form and details may be made therein without departing from the spirit and scope of the present invention as defined by the appended claims. In other words, the present invention is not limited in scope by its specified embodiments.

### BRIEF DESCRIPTION OF THE DRAWINGS

[FIG. 1] is a plan view of an embodiment of the bone conduction device according to the present invention (in a condition in which the front yoke is removed).

[FIG. 2] is a side view of the bone conduction device of the present invention (in a condition in which the front yoke is provided), taken along the line A-A in FIG. 1.

[FIG. 3] is a side view of the bone conduction device of the present invention (in a condition in which the front yoke is provided), taken along the line B-B in FIG. 1.

[FIG. 4] is a view illustrating an embodiment of the bone conduction device in a condition in which the device is mounted in its casing.

[FIG. 5] is a view illustrating another embodiment of the bone conduction device in a condition in which the device is mounted in its casing.

[FIG. 6] is a longitudinal sectional view of a conventional type of bone conduction device, illustrating the conventional device in construction.

[FIG. 7] is a view illustrating in construction the upper yoke of the conventional type of bone conduction device.

1. A bone conduction device comprises: a base yoke carrying both a voice coil and a magnet; and, a front yoke, which assumes a flat plate-like shape and is loosely disposed between: an upper surface of a magnetic pole of said base yoke; and, said front yoke to provide a necessary clearance between these yokes, wherein said device is characterized in that said clearance is produced by means of a resilient element, which is disposed in an outer peripheral portion of said base yoke to receive said front yoke thereon.

2. The bone conduction device as set forth in claim 1, wherein said base yoke is provided with a circular base; and, said resilient element assumes an arcing shape extending along said base.

3. The bone conduction device as set forth in claim 1, wherein said front yoke is fixedly mounted in an inner surface of a casing without using any screw.

4. The bone conduction device as set forth in claim 3, wherein said front yoke is fixedly mounted in a yoke reception portion of said inner surface of said casing in an insertion manner.

5. The bone conduction device as set forth in claim 1, wherein said magnet is disposed outside said voice coil.

6. The bone conduction device as set forth in claim 1, wherein said magnet is disposed inside said voice coil.

7. A bone conduction device comprises: a base yoke carrying both a voice coil and a magnet; and, a front yoke, which assumes a flat plate-like shape and is loosely disposed between: an upper surface of a magnetic pole of said base yoke; and, said front yoke to provide a necessary clearance between these yokes, wherein said device is characterized in that said clearance is produced by means of a damper, which is mounted on said base yoke to have its peripheral edge supported by an inner surface of said casing.

8. The bone conduction device as set forth in claim 7, wherein said front yoke is fixedly mounted on an inner surface of a casing without using any screw.

9. The bone conduction device as set forth in claim 8, wherein said front yoke is fixedly mounted in a yoke reception portion of said inner surface of said casing in an insertion manner.

10. The bone conduction device as set forth in claim 7, wherein said magnet is disposed outside said voice coil.

11. The bone conduction device as set forth in claim 7, wherein said magnet is disposed inside said voice coil.
